(19) United States
(12) Patent Application Publication
(10) Pub. No.: US 2017/0327353 A1
(43) Pub. Date: Nov. 16, 2017

(54) CRANE AND LATTICE MAST SECTION FOR A LATTICE MAST OF A CRANE OF THIS TYPE

(71) Applicant: TEREX GLOBAL GMBH, Schaffhausen (CH)

(72) Inventors: Frank SCHNITTKER, Würzburg (DE); Walter ZIMMER, Sulzbach (DE); Hans-Peter FRANZEN, Walshausen (DE); Alfons WECKBECKER, Zweibrücken (DE)

(21) Appl. No.: 15/667,140

(22) Filed: Aug. 2, 2017

Related U.S. Application Data
(62) Division of application No. 14/443,869, filed on May 19, 2015.

(30) Foreign Application Priority Data
Nov. 19, 2012 (DE) 10 2012 221 031.8

(51) Int. Cl. B66C 23/70; B66C 23/34; B66C 23/16

(52) U.S. Cl. CPC B66C 23/70; B66C 23/16; B66C 23/344

(57) ABSTRACT

A multi-component lattice mast section comprises a longitudinal axis, a plurality of chord elements extending along the longitudinal axis, a plurality of connection bars interconnecting in each case two adjacent chord elements, a lattice mast cross-sectional surface area with a lattice mast width and a lattice mast height, the lattice mast cross-sectional surface area being oriented perpendicular to the longitudinal axis, and at least two detachably interconnectable lattice mast assemblies, with each of the lattice mast assemblies having a lattice mast assembly width smaller than the lattice mast width and/or a lattice mast assembly height smaller than the lattice mast height, and with the connection bars being firmly connection to a chord element in a working arrangement.

### FIELD OF THE INVENTION

The invention relates to a crane and to a lattice mast section for a lattice mast of a crane of this type.

### BACKGROUND OF THE INVENTION

Lattice mast cranes have been known from prior art for a long time. For structural reasons, it is advantageous to design a cross-section of a lattice mast in such a way as to have a greatest possible surface area in a direction perpendicular to its longitudinal extension. A lattice mast having a large lattice mast width of for instance 4 m allows an improved use to be made of the material, thus ensuring a low own weight/load bearing capacity ratio of the lattice mast. A lattice mast of this type having a lattice mast width of for instance 4 m is difficult to transport. In particular, transport widths of more than 4 m and transport heights of more than 3 m are no longer transportable on conventional transport routes such as roads, rails or waterways or it is extremely difficult to do so. If a transport vehicle exceeds at least one of the transport dimensions listed above, a transport of this type needs, for instance due to its excess width, to be handled as a special transport according to German Road Traffic Regulations, in other words it needs to be escorted, resulting in a much more difficult and expensive transport. The short-term transport mobility is limited. In particular the dispatching of a lattice mast of this type is restricted considerably. These restrictions apply not only in Germany but also in many other countries. In order to facilitate the transport of a lattice mast, a width of 2.50 m and a height of 3.00 m should not be exceeded. This transport width and transport height allows the lattice mast to be transported on conventional trucks. A lattice mast of this type can be transported to virtually any destination in Germany.

A lattice mast section for a large lattice mast crane and a method for its erection are known from DE 10 2006 060 347 B4. The lattice mast section has four corner posts that are interconnected by means of null bars and diagonal bars. The lattice mast section may be divided in two and transported in this disassembled state. In order to allow the lattice mast section to be converted from a working arrangement into a transport arrangement, the interconnecting null bars and/or diagonal bars need to be arranged on the corner posts in a pivotable manner. An arrangement of this type is complicated and reduces the load bearing capacity of the lattice mast section.

An expandable lattice support structure is known from EP 1 802 823 A1.

A lattice support structure comprising lattice bars articulated to each other is known from DE 20 2006 014 789 U1. The lattice support structure has lattice bars extending in a longitudinal direction. The lattice support structure is foldable inwardly or outwardly to reduce or increase a cross-sectional surface of the lattice support structure. A lattice support structure of this type is complicated and cumbersome to use.

### SUMMARY OF THE INVENTION

The present invention is based on the object of designing a lattice mast section for a lattice mast in such a way as to have a high load bearing capacity on the one hand and to be easily transportable on the other, the lattice mast section in particular being easily convertible from a transport arrangement into a working arrangement.

This object is achieved according to the invention by a multi-component lattice mast section comprising a longitudinal axis, a plurality of chord elements extending along the longitudinal axis, a plurality of connection bars interconnecting in each case two adjacent chord elements, a lattice mast cross-sectional surface area oriented perpendicular to the longitudinal axis, the surface area having a lattice mast width and a lattice mast height, and at least two detachably interconnectable lattice mast assemblies, with each of the lattice mast assemblies having a lattice mast assembly width smaller than the lattice mast width and/or a lattice mast assembly height smaller than the lattice mast height, and with the connection bars being firmly connected to a chord element in a working arrangement.

It was recognized according to the invention that a lattice mast section has a multi-component configuration including at least two lattice mast assemblies detachably connectable to each other. In a working arrangement, in other words when the lattice mast assemblies are interconnected to form the lattice mast section, the lattice mast section has a longitudinal axis and a lattice mast cross-sectional surface area oriented perpendicular to the longitudinal axis. The lattice mast cross-sectional surface area has a lattice mast width amounting to in particular up to 4.0 m or more. Furthermore, the lattice mast cross-sectional surface area has a lattice mast height amounting in particular to up to 3.0 m or more. In particular, the lattice mast height amounts to 4.0 m or more. The lattice mast cross-sectional surface area has an in particular rectangular, in particular square, shape. The multi-component lattice mast section has a high load bearing capacity in the working arrangement. The lattice mast assemblies can be separated from each other at least in a separation plane oriented in particular parallel to the longitudinal axis. Each of the lattice mast assemblies has a respective lattice mast assembly width smaller than the lattice mast width. As an alternative or in addition thereto, each lattice mast assembly has a lattice mast assembly height smaller than the lattice mast height. As a result, the individual lattice mast assemblies can be arranged on a transportation vehicle, for example, in a space-saving manner when the lattice mast section is in the transport arrangement, thus in particular facilitating a transport on roads. In other words, the essential feature is that the lattice mast section according to the invention has a lattice mast cross-sectional surface area in the working arrangement such that the lattice mast provides a sufficient load bearing capacity. Since the lattice mast section is dividable in a direction parallel to the longitudinal axis, in other words it is dividable into a plurality of lattice mast assemblies, each of the lattice mast assemblies has a cross-sectional surface area smaller than that of the lattice mast section. The individual lattice mast assemblies or several lattice mast assemblies taken together can be transported in an advantageous manner. The lattice mast section has a simple structure and, what is more, a stable configuration in a working arrangement. Since, in a working arrangement, the connection bars are firmly connected to the chord elements, the lattice mast section has an increased load bearing capacity. In particular, it is conceivable to omit pivot connections, which usually result in a reduced stability and load bearing capacity of a lattice mast section of this type. In particular, a lattice mast section of this type comprises a large number of equal parts. It is in particular conceivable for chord elements extending along the longitudinal axis to be configured identically, the chord elements for instance being configured as tubes. It is conceivable as well for connection bars used to interconnect in each case two adjacent chord elements to be configured identically. Due to the increased number of equal parts, the storage costs and in particular the acquisition costs of a lattice mast section of this type are reduced while furthermore providing for an increased flexibility when designing a lattice mast section. A setting-up procedure for the lattice mast section can be facilitated by using modular equal parts, thus in particular facilitating the logistics procedures before, during and after the setting-up procedure. Using modular basic elements, a crane operator is for instance able to form a lattice tower and/or a lattice boom such as to have a lattice mast cross-section with different widths and/or heights by replicating an identical basic pattern of the lattice mast cross-section, for example. The crane operator's expenditures for modular basic elements of this type are compensated for by the additional value provided by the upgradable crane.

A lattice mast section having a lattice mast assembly width and a lattice mast assembly height that do not exceed maximum permissible dimensions for a transport on public roads is easily transportable on roads.

A lattice mast section having a lattice mast assembly width that amounts to no more than 4.0 m and/or a lattice mast assembly height that amounts to no more than 4.0 m allows for easier transport, for instance also on rails and/or waterways.

A lattice mast section having connection bars has a particularly simple structure. Suitable connection bars are for instance connection bars, so-called null bars, arranged perpendicular to the chord elements. The connection bars may also be arranged in a plane spanned by two adjacent chord elements in a direction transverse to the mentioned chord element. Connection bars of this type are also referred to as diagonal bars.

A lattice mast section having lattice mast assemblies that are configured identically reduces the storage costs for the lattice mast assemblies. In particular, an assembly of identical lattice mast assemblies to form a lattice mast section is facilitated.

A lattice mast section having lattice mast assemblies configured in particular symmetrically, in particular with double symmetry, in other words the lattice mast assemblies form in each case a half or a quarter of the lattice mast cross-sectional surface area, with in particular the lattice mast assembly width amounting to no more than half and in particular no more than a quarter of the lattice mast width, and with in particular the lattice mast assembly height amounting to no more than half and in particular no more than a quarter of the lattice mast height. The assembly of the lattice mast assemblies to form the lattice mast section is therefore facilitated. The lattice mast assemblies are pre-assembled, thus allowing the lattice mast assemblies to be quickly converted from the transport arrangement into the working arrangement.

A lattice mast section in which connection bars, in particular null bars, of two lattice mast assemblies are interconnected, in particular by plugging, the connection bars in particular being interconnected using a respective connection element, in particular a sleeve, a clamp or divided connection shells, ensures a particularly simple interconnection of the lattice mast assemblies, which are in particular interconnectable manually. It is in particular conceivable as well for a connection bar of a first lattice mast assembly to be plugged into a corresponding connection bar of a second lattice mast assembly. In other words, this means that the corresponding connection bar of the second lattice mast assembly has an integral connection element, thus allowing separate connection elements to be omitted.

A lattice mast section provided with connection bars that are in each case interconnected by means of a connection element, in particular a sleeve, a clamp or divided connection shells, allows the lattice mast assemblies to be interconnected quickly and easily. A connection element allows the connection bars of two lattice mast assemblies to be interconnected directly. The connection element may in particular be configured as a slip-on sleeve, a clamp having a hinge oriented along the connection bars or as two connection shells substantially configured as half shells. The connection shells may in particular be screwed to the respective connection bars of the lattice mast assemblies using connection screws. Bolt connections are conceivable as well.

A lattice mast section comprises pre-assembled lattice mast assemblies. The lattice mast assemblies are interconnected in particular in the region of diagonal bars, in particular using bolts or screws.

A lattice mast section in which a longitudinal connection axis in particular of a connection bolt or a connection screw is oriented horizontally has a connection element such as a connection bolt or a connection screw. The connection element has a longitudinal connection axis oriented horizontally, thus providing for a more advantageous load case of the bolt in the working arrangement. In other words, the longitudinal connection axis is oriented parallel to one of the horizontal chord planes. One chord plane is defined by in each case two chord elements arranged adjacent to each other.

A lattice mast section having at least two lattice mast assemblies that are interconnectable to form a transport unit, the transport unit having a transport unit width smaller than the lattice mast width and/or a transport unit height smaller than the lattice mast height, allows at least two lattice mast assemblies to be interconnected to form a transport unit. A transport unit of this type can be arranged on a transport vehicle in a particularly space-saving manner while at the same time allowing the lattice mast assemblies to be interconnected, in particular detachably, to form the transport unit. The transport unit is intrinsically stable, allowing a firm, detachable connection to be formed between the lattice mast assemblies. The transport unit has a transport unit width smaller than the lattice mast width and/or a transport unit height smaller than the lattice mast height. In particular, it is conceivable as well that four lattice mast assemblies are interconnectable such as to form one transport unit. In particular, the lattice mast assemblies have a periodic truss structure along the longitudinal axis. When forming a transport unit, it is in particular conceivable to arrange and interconnect the lattice mast assemblies in a space-saving staggered configuration along the longitudinal axis. Depending on transport height restrictions and/or transport weight restrictions, it is conceivable for two or four lattice mast assemblies to be nested into each other when forming a transport unit, thus allowing a more efficient use to be made of a permissible transport width and/or a permissible transport height when transporting the lattice mast assemblies. A lattice mast assembly transport of this type is efficient, allowing an improved use to be made of existing, predetermined and in particular unchangeable transport capacities defined by the design, in particular of the public infrastructure.

A lattice mast section configured modularly, in other words having a modular structure in which the lattice mast assemblies are in particular configured as chord elements interconnectable individually, as connection bars, in particular diagonal bars and/or null bars interconnecting in each case two adjacent chord elements, and/or as head pieces attachable to the front ends of the chord elements, wherein in particular at least one lattice mast assembly is an upper chord or a lower chord, and wherein the at least one lattice mast assembly has two chord elements and a plurality of connection bars, in particular diagonal bars and/or null bars interconnecting the two chord elements firmly, in particular permanently, provides a large degree of freedom when designing the lattice mast section.

A lattice mast section comprising at least one lattice mast assembly configured as an upper chord or a lower chord, with the at least one lattice mast assembly having two chord elements and a plurality of connection bars, in particular diagonal bars and/or null bars, interconnecting the two chord elements firmly, in particular permanently, allows at least one lattice mast assembly such as an upper chord or a lower chord to be pre-assembled in a time-saving manner. The upper chord or the lower chord comprises in each case two lattice elements firmly interconnected by a plurality of connection bars. In particular, the connection bars are permanently connected to the lattice elements, in particular by welding. An upper chord or lower chord pre-assembled in this manner has a substantially flat configuration and is easier to transport.

A lattice mast section having lattice mast assemblies that are interconnected detachably ensures a quick and simple interconnection of the lattice mast assemblies. For instance, it is conceivable to interconnect the lattice mast assemblies using bolts or screws. It is conceivable as well to provide a so-called twistlock connection for interconnecting the lattice mast assemblies. Connections of this type are for instance used in the nautical sector for handling containers. A twistlock connection is a positive, and therefore quick and secure connection produced by placing a hole on a locking element provided with an axis of rotation. The locking element is rotated so as to engage the hole in such a way that a positive connection is formed. It is conceivable as well to provide a bayonet lock as an alternative to the twistlock connection.

A lattice mast section having four chord elements extending along the longitudinal axis allows chord elements to be interconnected by an articulated support structure in particular being arranged in a plane oriented perpendicular to the longitudinal axis. The lattice mast section has an increased load bearing capacity. The lattice mast section is easy to assemble.

A lattice mast section having an articulated support structure being arranged in a plane oriented perpendicular to the longitudinal axis is easy to handle. The articulated support structure is easily accessible, in particular from a front end of the lattice mast section, thus facilitating the conversion from the transport arrangement to the working arrangement and vice versa.

A lattice mast section in which two adjacent chord elements are interconnected by a null bar ensures a simple and at the same time stable structure of the lattice mast section such that a high load bearing capacity is achieved.

A lattice mast section having an articulated support structure that has a central articulated element arranged in particular concentrically to the longitudinal axis and four articulated bars articulated thereto or, alternatively, two articulated elements and in each case two articulated bars articulated thereto, the articulated elements being interconnected by a pendulum support, has a simple structure, or ensures a greater degree of freedom when designing the articulated support structure.

Furthermore, the invention is based on the object of providing a crane having a lattice mast in such a way that the crane has a sufficient load bearing capacity in a working arrangement while at the same time providing for an easy transport thereof.

This object is achieved according to the invention by a crane comprising a lattice tower having a lattice mast comprising at least one lattice mast section according to the invention and/or a lattice boom having a lattice mast comprising at least one lattice mast section according to the invention.

It was recognized according to the invention that at least one lattice mast section can be used for a lattice mast. In particular, a plurality of lattice mast sections can be arranged one behind the other along the longitudinal axis, the lattice mast sections being interconnected by head pieces. A lattice mast may have up to five or more lattice mast sections. A lattice mast of this type is for instance used as a lattice boom and/or a lattice tower for a crane. The crane may have a lattice boom and/or a lattice tower each comprising at least one lattice mast section according to the invention. The resulting advantages for the lattice mast and the crane substantially correspond to the advantages of the lattice mast section to which reference is made.

Exemplary embodiments of the invention will hereinafter be explained in more detail with reference to the drawing.

### BRIEF DESCRIPTION OF THE DRAWING

FIG. 1 shows a diagrammatic side view of a crane comprising a lattice tower and a lattice jib comprising a plurality of lattice mast sections according to the invention,

FIG. 2 shows a side view of a crawler crane with a lattice boom comprising a plurality of lattice mast sections according to the invention,

FIG. 3 shows a perspective view of a lattice mast section according to a first embodiment,

FIG. 4 shows an enlarged view of detail IV in FIG. 3,

FIG. 5 shows a side view of a lattice mast section according to another embodiment in a working arrangement,

FIG. 6a shows a front view of the lattice mast section according to arrow VI a in FIG. 5,

FIG. 6b shows an enlarged view of detail VI b in FIG. 6a,

FIG. 7 shows a sectional view along line VII-VII in FIG. 5,

FIG. 7a shows an enlarged view of detail VII a in FIG. 7,

FIG. 7b shows a diagrammatic detailed view according to FIG. 5 of a connection lug secured to a chord element,

FIG. 8 shows a side view of lattice mast assemblies of the lattice mast section in FIG. 5 in a transport arrangement, the lattice mast assemblies being combined in transport units,

FIGS. 9a, 9b show a front view of the transport units according to FIG. 8,

FIG. 10 shows a side view, corresponding to FIG. 8, of the lattice mast assemblies of the lattice mast section combined in a single transport unit,

FIG. 11 shows a front view, corresponding to FIG. 10, of the transport unit,

FIG. 12 shows a top view of the transport unit in FIG. 10,

FIG. 13 shows a diagrammatic view of a lattice mast section according to another embodiment in a working arrangement,

FIG. 14 shows an enlarged detailed view of a modular element in the form of a lattice mast assembly for a lattice mast section in FIG. 13,

FIG. 15 shows a diagrammatic perspective view of two lattice mast sections according to another embodiment in a working arrangement, the lattice mast sections being arranged one behind the other along a longitudinal axis,

FIG. 16 shows a diagrammatic perspective view of a lattice mast section according to another embodiment in a working arrangement,

FIG. 17a shows a front view of an articulated support structure for a lattice mast section according to FIG. 16 in a transport arrangement,

FIG. 17b shows a front view, corresponding to FIG. 17a, of a lattice mast section comprising four pivotable articulated bars, and

FIG. 18 shows a view, similar to FIG. 16, of a lattice mast section of another embodiment in a working arrangement.

### DESCRIPTION OF THE PREFERRED EMBODIMENTS

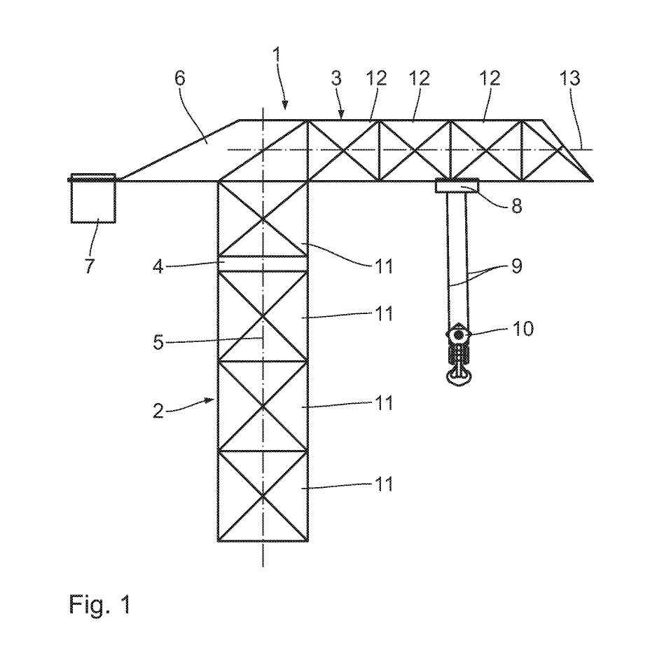

A lattice mast crane 1 shown diagrammatically in FIG. 1 has a substantially vertical lattice tower 2 and a substantially horizontal lattice jib 3 connected thereto. In an upper region of the lattice tower 2, in other words adjacent to the lattice jib 3, a rotary joint 4 is provided at the lattice tower 2, the rotary joint 4 allowing the upper portion of the lattice tower 2 to be rotated relative to the lower portion about a longitudinal mast axis 5. A lattice mast crane 1 of this type is also referred to as tower crane.

The lattice tower 2 may be supported on a ground via supporting elements (not shown). It is conceivable as well for the lattice tower 2 to be arranged on an undercarriage comprising a running gear, in particular a tire running gear.

According to the illustration in FIG. 1, the lattice jib 3 extends from the lattice tower 2 to the right. At an opposite end of the lattice tower 2, a jib counterpart 6 comprising a counterweight 7 is provided.

A trolley 8 known per se comprising rope cables 9 and a pulley 10 fastened thereto is provided at an underside of the lattice boom 3.

The lattice tower 2 comprises a plurality of tower lattice mast sections 11. The lattice jib 3 comprises a plurality of jib lattice mast sections 12. The lattice mast sections 11, 12 are substantially identical but may differ from each other in terms of their dimensions, for example. In order to improve the structural properties of the lattice mast crane 1, it is advantageous if the lattice mast sections 11, 12 have a maximum cross-section in a direction perpendicular to the longitudinal tower axis 5 or to a longitudinal jib axis 13.

The tower lattice mast sections 11 are arranged one above the other along the longitudinal tower axis 5. The jib lattice mast sections 12 are arranged one behind the other along the longitudinal jib axis 13. It is conceivable as well to use more or less than the lattice mast sections 11, 12 shown in FIG. 1 for a lattice tower 2 or a lattice jib 3, in particular to reach a necessary height of the lattice tower 2 and/or a length of the lattice jib 3. It is in particular conceivable to adapt the height of the lattice mast crane 1 and the length of the lattice jib 3 in an individual and flexible manner to meet the respective requirements.

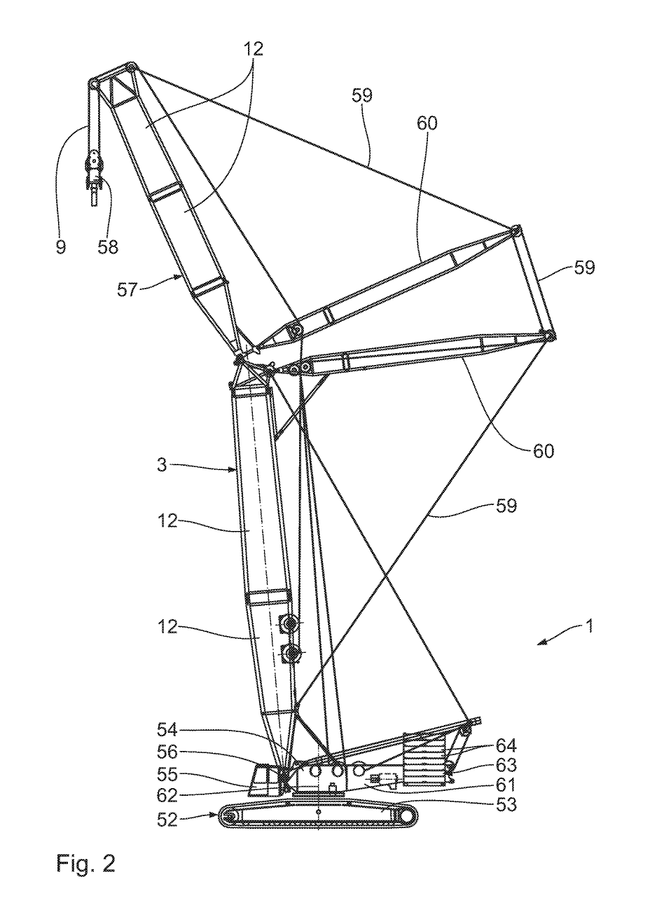

FIG. 2 shows another embodiment of a lattice mast crane 1. Components corresponding to those already explained above with reference to FIG. 1 are designated by the same reference numerals and are not discussed in detail again.

The crane 1 is configured as a crawler crane comprising two crawler running gears 53 arranged parallel to each other on an undercarriage 52. The superstructure 54 is mounted to the undercarriage 52 for rotation about a vertical axis of rotation 62, the superstructure 54 being provided with an operating cabin 55 and a lattice boom 3 pivotable about a horizontal axis 56. At an end of the boom 3 opposite to the horizontal axis 56, said boom 3 is connected to a jib 57 in such a way that a pivotable connection is formed here as well. The tip of the jib 57 is provided with a pulley 58 comprising a hook for lifting, holding, and displacing of loads. The boom 3 and the jib 57 are anchored using an anchoring system comprising a plurality of guy lines 59 and struts 60.

A substantially horizontal cross carrier 61 of the superstructure 54 is provided with a counterweight assembly 63 arranged at a distance from the axis of rotation 62. The counterweight assembly 63 comprises a plurality of counterweights 64 placed on top of each other, wherein the counterweight assembly 63 may have two stacks of individual counterweights 64 arranged on each of the sides of the cross-carrier 61.

The lattice boom 3 and/or jib 57 may comprise a plurality of lattice mast sections 12.

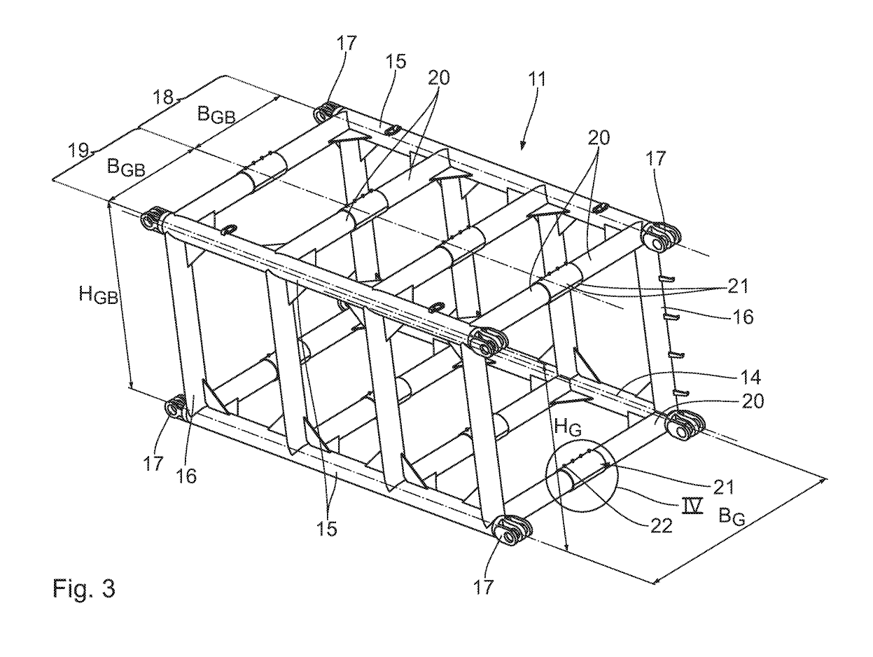

In the following sections, a lattice mast section according to a first embodiment will be explained in more detail with reference to FIG. 3. The lattice mast section 11 has a longitudinal axis 14, four chord elements 15 extending along the longitudinal axis 14, and a plurality of connection bars 16 interconnecting in each case two adjacent chord elements 15. The chord elements 15 have a tubular shape and are also referred to as chord tubes 15. The front ends of the chord tubes 15 are each provided with a respective head piece 17. The head pieces 17 are screwed into the chord tubes 15, are welded to the chord elements 15 or connected to ends of the chord tubes 15 using bolts. The head pieces 17 allow a plurality of lattice mast sections 11 to be quickly and securely interconnected along the longitudinal axis 14.

The connection bars 16 are each oriented perpendicular to the chord elements 14. The connection bars 16 are also referred to as null bars. The connection bars 16 extend away from the chord elements 15 in a direction perpendicular to a chord element longitudinal axis.

The lattice mast section 11 has two lattice mast assemblies 18, 19. The lattice mast assembly 18 comprises two chord elements 15 arranged one above the other in a vertical plane according to FIG. 2. The two chord members 15 are interconnected by four connection bars 16 oriented in each case vertically. According to the illustration in FIG. 2, four connection bars 20 are provided that extend to the left from the two chord elements 15, in other words in a direction perpendicular to the vertical plane. The connection bars 20 have a length smaller than that of the connection bars 16. In a plane perpendicular to the longitudinal axis 14, the lattice mast assembly 18 has an open, substantially U-shaped frame structure comprising a vertical connection bar 16 and two connection bars 20 arranged at the ends of the connection bar 16, the connection bars 20 extending away therefrom in a perpendicular direction.

The lattice mast assembly 19 is substantially identical to the lattice mast assembly 18. The lattice mast assembly 19 comprises two chord elements 15 arranged in a vertical plane, the chord elements 15 being interconnected by four connection bars 16 arranged in each case perpendicular thereto. Each of the upper and lower chord elements 15 is provided with four connection bars 20 extending away from the vertical plane in a direction perpendicular thereto.

The connection bars 20 of the lattice mast assembly 18 and the lattice mast assembly 19 are arranged in an inline configuration such as to face each other. In order to connect the two lattice mast assemblies 18, 19 to form the lattice mast section 11, the lattice mast assemblies 18, 19 are arranged mirror symmetrically to each other in such a way that the openings of the open, U-shaped frame structures face each other. The connection bars 20 of the lattice mast assemblies 18, 19 are formed by a connection element in the form of two-piece connection shells 21. The connection shells 21 are connected to the respective connection bars using connection screws 22. The lattice mast assemblies 18, 19 are interconnectable or detachable from each other relative to a vertically oriented separation plane. The separation plane is in particular parallel to the vertical planes spanned by chord elements 15 of the respective lattice mast assembly 18, 19. The separation plane is in particular arranged centrally between the two vertical planes. The separation plane is a symmetry plane of the lattice mast section 11.

The connection bars 20 are each plugged into the respective connection shells 21 and connected to the connection shells 21 using the connection screws 22. The connection shells 21 have a horizontal separation plane. The connection shells 21 are quickly and easily attachable and connectable to the connection bars 20. Instead of the connection shells 21, a connection element may also be configured as a bushing, in other words as a one-piece sleeve. In this case, the bushing may be provided with an internal thread allowing the bushing to be screwed to the connection bars 20. A bushing of this type is also referred to as threaded bushing. It is conceivable as well to use the threaded bushing as a clasp nut. For instance, it is conceivable for the connection bars 20 to be provided with external threads having opposite pitches corresponding to the internal thread of the clasp nut. When the clasp nut is rotated, the connection bars 20 to be interconnected are axially displaced along a longitudinal axis relative to the clasp nut. Depending on the direction of rotation, both connection bars 20 are moved towards or away from each other along the longitudinal axis at the same time. In other words, when the clasp nut is tightened, this causes the connection bars 20 to be tensioned, in other words preloaded, axially along the respective longitudinal axis. When preloaded in this manner, this may result in an advantageous initial preloading state that is advantageous in the event of a subsequent loading and may increase the load bearing capacity of the lattice boom. It is conceivable as well for the connection shells 21 to be articulated to each other using a hinge. The connection shells 21 are then configured as clamps. It is conceivable as well for the connection element to be integrated in the connection bars 20 of one of the lattice mast assemblies. Furthermore, it is conceivable that the connection bars 20 of the first lattice mast assemblies are configured in a tubular manner having an internal diameter such that the connection bars 20 of the second lattice mast assembly are directly insertable therein. The external diameter of the connection bars 20 of the second lattice mast assembly correspond to an internal diameter of the connection bars 20 of the first lattice mast assembly. In order to facilitate an assembly and in particular a disassembly of the two lattice mast assemblies, the connection bars 20 inserted into each other, in particular those of the second lattice mast assembly, may at least partly be conical. Connections of this type are also referred to as tapered joints.

According to the exemplary embodiment shown in FIG. 3, the lattice mast section has a rectangular lattice mast cross-sectional surface area oriented perpendicular to the longitudinal axis 14. The lattice mast cross-sectional surface area has a lattice mast width B_{G} amounting to in particular 4.0 m or more. Furthermore, the lattice mast cross-sectional surface area has a lattice mast height H_{G} of at least 3.0 m or more. The lattice mast section 11 has a high load bearing capacity. Due to the vertical separation plane of the lattice mast assemblies 18, 19, the lattice mast assemblies 18, 19 each have a lattice mast assembly width B_{GB} smaller than the lattice mast width B_{G}. In the vertical direction, in other words along the connection bars 16, the lattice mast assemblies 18, 19 are not separated. This means that a lattice mast assembly height H_{GB} is identical to the lattice mast height H_{G}. The lattice mast assembly width B_{GB} and the lattice mast assembly height H_{GB} do not exceed the maximum permissible dimensions for a transport on a public road, in particular in Germany. In particular, the lattice mast assembly width B_{GB} amounts to no more than 4.0 m. The lattice mast assembly height H_{GB} amounts to no more than 4.0 m.

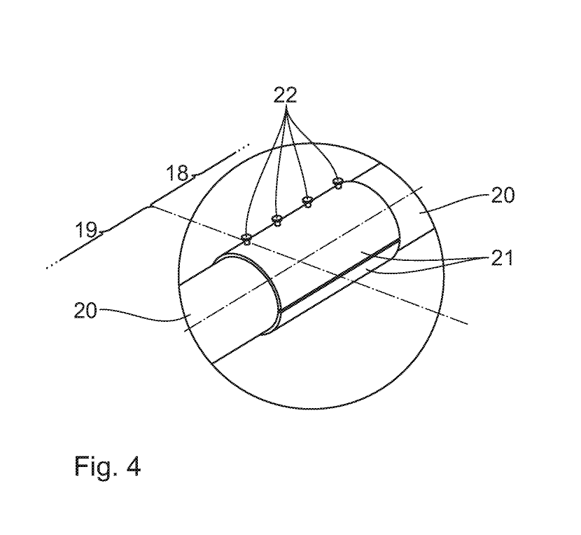

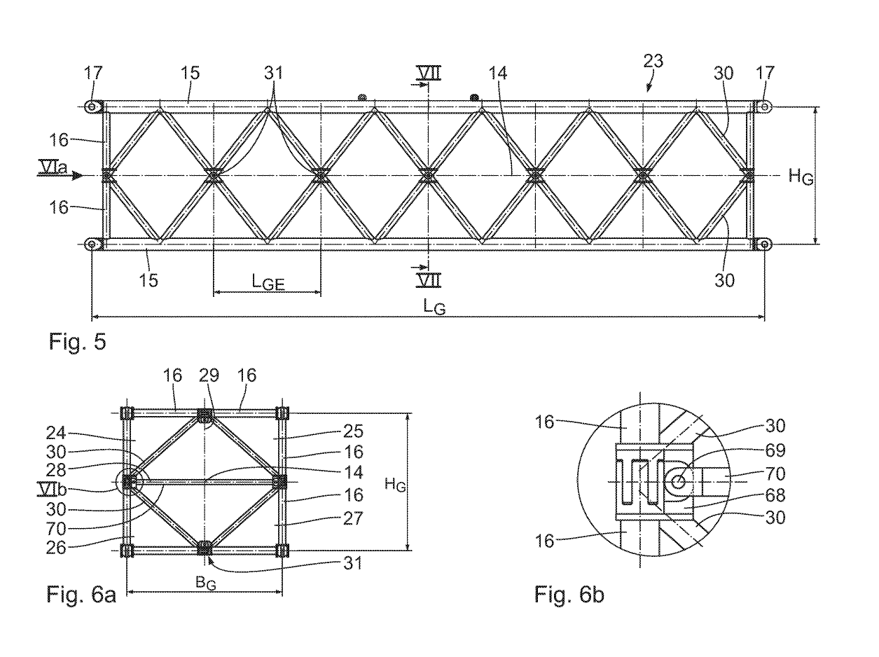

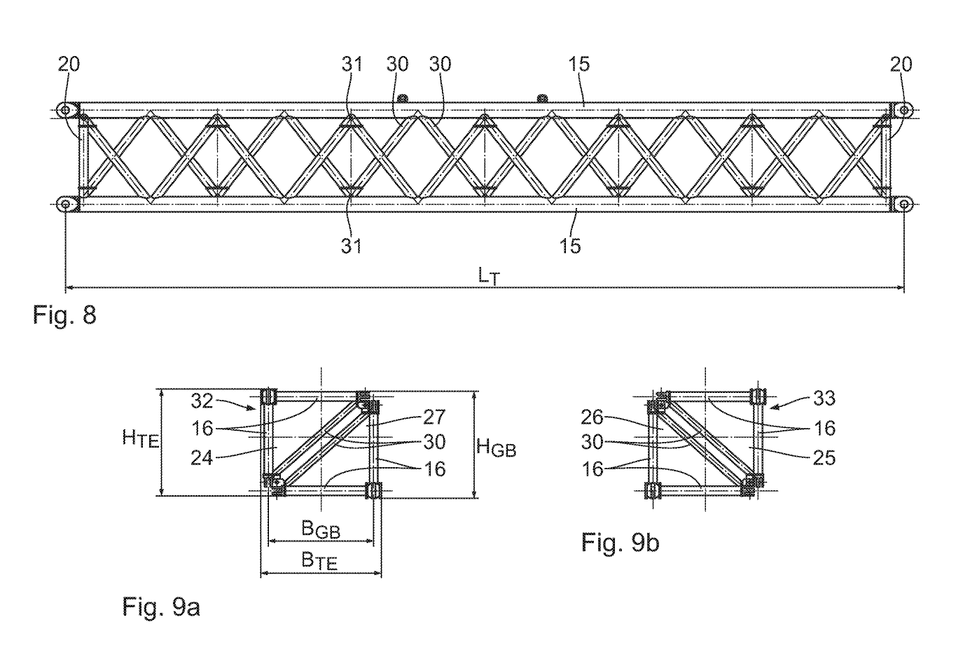

FIGS. 5 to 9b show another embodiment of a lattice mast section 23. Components corresponding to those already explained above with reference to FIGS. 1 to 4 are designated by the same reference numerals and are not discussed in detail again.

The lattice mast section 23 has four lattice mast assemblies 24, 25, 26, 27, each of which making up substantially a quarter of the lattice mast cross-sectional surface area. The lattice mast section 23 has a lattice mast length L_{G} along the longitudinal axis 14 of for instance 12 m. The lattice mast length L_{G} substantially corresponds to six times the length L_{GE} of a lattice mast unit. The length L_{GE} of a lattice mast unit is also referred to as partition length. The length L_{GE} of a lattice mast unit along the longitudinal axis 14 is obtained from a—in particular multiple—distance between two adjacent connection lugs 31, which will be explained in more detail below. The lattice mast length L_{G} further comprises a double hole distance between the head pieces 17. The hole distance between the head pieces 17 corresponds to a distance along the longitudinal axis 14 from the front end of the chord element 15 to a hole center of the head piece 17. The lattice mast height H_{G} amounts to 2.45 m. The lattice mast width B_{G} amounts to 2.77 m. The lattice mast section 23 according to the illustrated embodiment has two separation planes intersecting in the longitudinal axis 14, namely a horizontal separation plane 28 and a vertical separation plane 29. Each of the four lattice mast assemblies 24, 25, 26, 27 has one chord element, two connection bars 16 configured as null bars being in each case arranged at the front ends as well as a plurality of connection bars 30 arranged diagonally, so-called diagonal bars. In the working arrangement shown in FIG. 5 to FIG. 7a in which the lattice mast section 23 may be mounted to a lattice tower or a lattice boom, the lattice mast assemblies 24 to 27 are in each case interconnected by connection elements in the form of connection lugs 31 in the region of the ends of the diagonal rods 30.

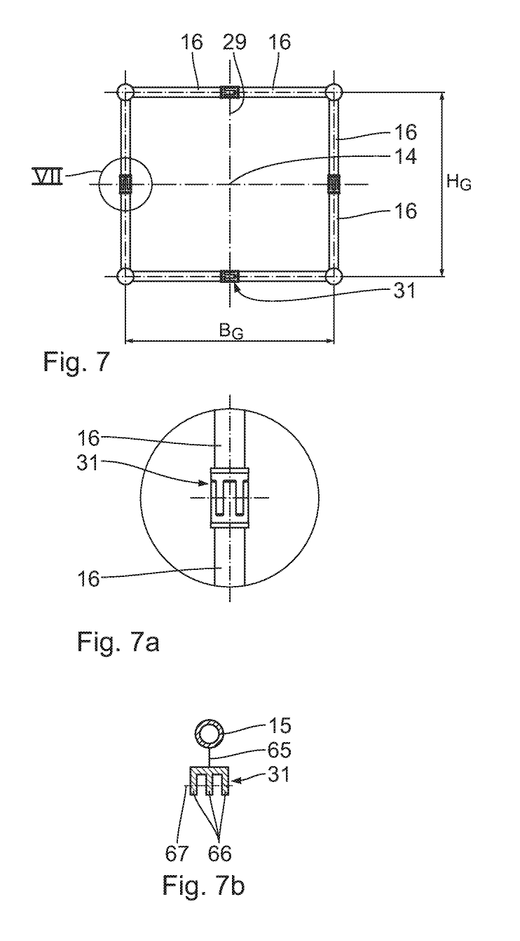

A connection lug 31 is shown diagrammatically in FIG. 7b. FIG. 7b shows a sectional view in a plane perpendicular to the longitudinal axis 14. The tubular chord element 15 has a connection piece 65 in particular welded thereto. The connection piece 65 extends away from the chord element 15 in a direction perpendicular thereto. The connection piece 65 is for instance a null bar 16. The connection lug 31 is secured to the connection piece 65, in particular to the front end thereof. The connection lug 31 is in particular welded to the connection piece 65. The connection lug 31 has a triple-layer configuration, in other words the connection lug 31 has three lug webs 66 arranged in each case perpendicular to the chord element 15. The lug webs 66 are each provided with through-holes arranged inline with each other, the through-holes being arranged concentrically to a connection axis 67. This means that the connection axis 67 of the connection lug 31 is rotated through 90° in space relative to the longitudinal extension of the chord element 15. The triple-layer configuration of the connection lug 31 allows a pivot connection having an increased connection strength to be provided between the connection lug 31 and a corresponding counter-piece. A connection of this type is stable, thus in particular ensuring a safe and hazard-free transport of a transport unit. The connection lugs 31 are each provided with a through-hole. In the working arrangement of the lattice mast section 23, the lattice mast assemblies 24 to 27 are arranged in such a way that the connection lugs 31 of in each case two adjacent lattice mast assemblies 24, 25 and 24, 26, and 26, 27 and 25, 27 overlap in such a way that the through-holes of the connection lugs 31 are inline with each other. The through-holes arranged inline with each other allow a connection element for instance in the form of a connection bolt or a connection screw to be inserted. A longitudinal connection axis of the connection element is parallel to the connection axis 67 and oriented in particular horizontally, in other words parallel to the chord planes spanned by the chord elements 15. In particular, the longitudinal connection axes of the connection elements are oriented perpendicular to the longitudinal axis 14 of the lattice mast section 23.

The lattice mast assemblies 24, 27 and 25, 26 may be combined in pairs to form a transport unit 32 or 33, respectively, in other words a total of two transport units 32 and 33.The transport unit 32 comprises the lattice mast assemblies 24 and 27, which—according to FIG. 6a —have diagonal bars 30 oriented from the bottom left-hand side to the upper right-hand side. In the transport arrangement of the transport unit 32, the diagonal bars 30 of the lattice mast assemblies 24, 27 are arranged parallel and adjacent to each other. In the transport arrangement, the transport unit has a transport length L_{T} that is identical to the lattice mast length L_{G}. The connection bars 16 of the lattice mast assemblies 24, 27 substantially form a rectangle. The lattice mast assemblies 24, 27 each have a lattice mast assembly width B_{GB} and a lattice mast assembly height H_{GB}. In particular, both the lattice mast assembly width B_{GB} and the lattice mast assembly height H_{GB} are smaller than the lattice mast width B_{G} and the lattice mast height H_{G}. The lattice mast assemblies 24, 27 are interconnected by the connection lugs 31 to form the transport unit 32. This means that the connection lugs 31 allow the lattice mast assemblies to be interconnected such as to form a lattice mast section 23 on the one hand as well as transport units 32, 33 to be assembled therefrom on the other. In particular, it is not necessary to provide a plurality of connection elements configured and acting in different manners to achieve the working arrangement and the transport arrangement of the lattice mast section 23. The particularly advantageous use of the connection lug 31 can be seen in FIGS. 6a, 9a, 9b and 11. These Figures show that the triple-layer connection lug 31 has a connection piece 68 with a receiving hole 69 adjacent to one of the outer lug webs 66, in other words along the connection axis 67. In the working arrangement shown in FIGS. 6a, 6b, the connection pieces 68 of two adjacent lattice mast assemblies 24, 26 are arranged one behind the other in a direction perpendicular to the drawing plane. The connection pieces 68 of the lattice mast assemblies 24, 26 are arranged in such a way that the receiving holes 69 are in each case inline with each other. It is conceivable to interconnect the receiving holes 69 in said inline arrangement by means of a connection element such as a bolt, in particular a reinforcing bolt, or a reinforcing screw. At the same time, the receiving holes 69 arranged inline with each other allow a torque-proof pendulum support 70 to be joined thereto, the pendulum support 70 being used to further reinforce the lattice mast section 23.

As can in particular be seen from the illustrations in FIGS. 9a, 9b and 11 showing a transport arrangement of the lattice mast assemblies 24 to 27, the lattice mast assemblies can be arranged in such a way that the receiving holes 69 are inline with each other in a transport arrangement. In this arrangement, the lattice mast assemblies 24, 27 and 25, 26 are in each case interconnectable to form a transport unit.

The transport unit 32 formed by the two lattice mast assemblies 24, 27 has a transport unit width B_{TE} of for instance 1.72 m and a transport unit height H_{TE} of for instance 1.68 m. The transport unit width B_{TE} is smaller than the lattice mast width B_{G}. The transport unit height H_{TE} is smaller than the lattice mast height H_{G}.

The transport unit 33 comprises the lattice mast assemblies 25, 26 the diagonal bars 30 of which are oriented, according to the illustration in FIG. 6, from the bottom right-hand side to the upper left-hand side.

Corresponding to the transport unit 32, the lattice mast assemblies 25, 26 of the transport unit 33 are in each case interconnected using the connection lugs 31. The transport unit 33 has an identical transport unit width B_{TE} of 1.72 m and a transport unit height H_{TE} of 1.68 m.

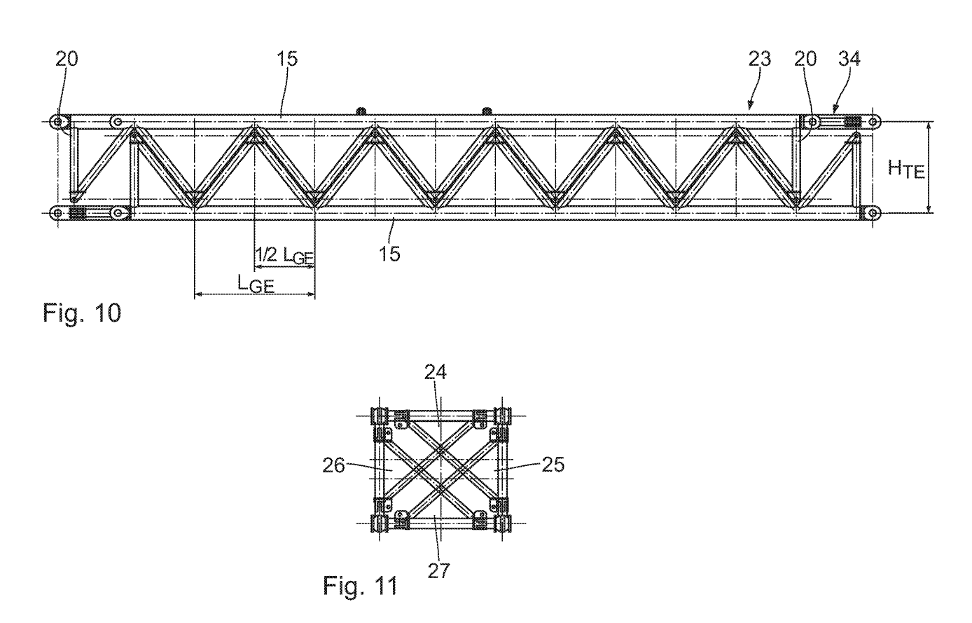

FIGS. 10 to 12 show an alternative arrangement of the lattice mast assemblies 24 to 27 in a transport arrangement. Seen along the longitudinal axis 14, the lattice mast assemblies 24, 27 and 25, 26 are arranged in pairs such as to be staggered inwardly towards each other by half the length L_{GE} of a lattice mast unit. A staggered arrangement of this type is also referred to as a nested arrangement or an arrangement overlapping by one partition length. It is conceivable for a lattice mast section of this type to be configured flexibly using one or more than one bar elements 39. For instance, the dimensions, in other words the lattice mast width and/or the lattice mast height can be adjusted in a defined manner. It is conceivable as well to change the cross-section of the lattice mast element in a defined manner for the lattice mast element to be adapted to a load to be expected, in particular a load direction, in order to achieve greater load bearing capacities. For instance, it is conceivable to directly interconnect two adjacent lattice mast sections nested into each other in order to achieve an increased horizontal cross-section. In particular, it is conceivable as well for the connection blocks 40 to be configured as a connection prism instead of connection blocks, the connection prism having a cross-section different from that of a square in a plane perpendicular to a longitudinal axis of the chord element 15. Possible cross-sectional shapes include a triangular shape, a hexagonal shape or any other shape.

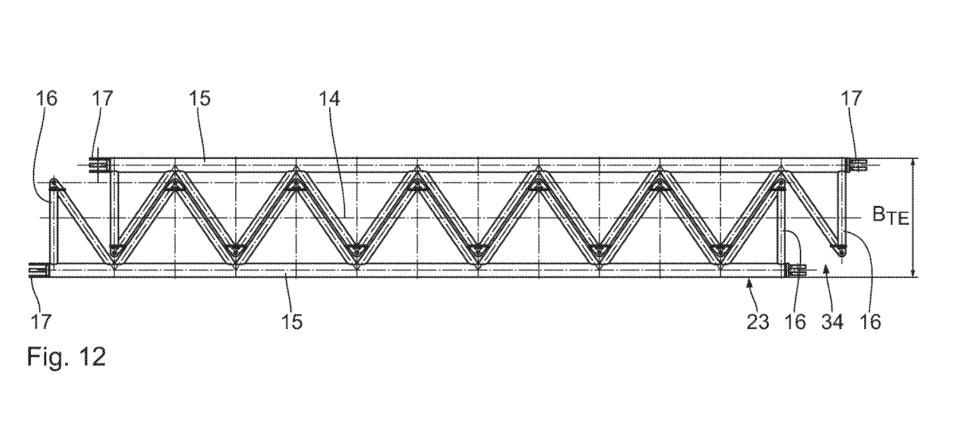

The mounting of the lattice mast assemblies 24, 27 staggered inwardly towards each other along the longitudinal axis 14 in the transport arrangement is particularly well visible in the top view shown in FIG. 12. The four lattice mast assemblies 24 to 27 are combined in one single transport unit 34 shown in a front view in FIG. 11. FIG. 10 shows rear head pieces 17 of the lattice mast assemblies arranged at the top of FIG. 12, the head pieces 17 being arranged in the region of the left end of the lattice mast section 23. They are, in other words, invisible edges represented by continuous lines in FIG. 10 for better clarity. Compared to the visible head pieces 17 of the lattice mast assemblies shown in the drawing plane at the bottom of FIG. 12, the invisible head pieces 17 are offset to the right by half a length L_{GE} of the lattice mast unit in FIG. 10. Correspondingly, the connection lugs 31 shown in FIG. 11 on the upper right-hand side and the lower left-hand side of the substantially rectangular cross-section of the four lattice mast assemblies 24 to 27 are invisible edges as well. This means that none of the triple-layer lug connections shown there is arranged in the illustration plane of FIG. 11, the lug connections being represented in continuous lines only for reasons of clarity. The transport unit 34 has a transport unit height H_{TE} of in particular 1.45 m and a transport unit width B_{TE} of in particular 1.88 m. The arrangement of the lattice mast assemblies 24, 27 and 25, 26 arranged such as to be staggered relative to each other in the direction of the longitudinal axis 14 is particularly well visible in FIG. 10.

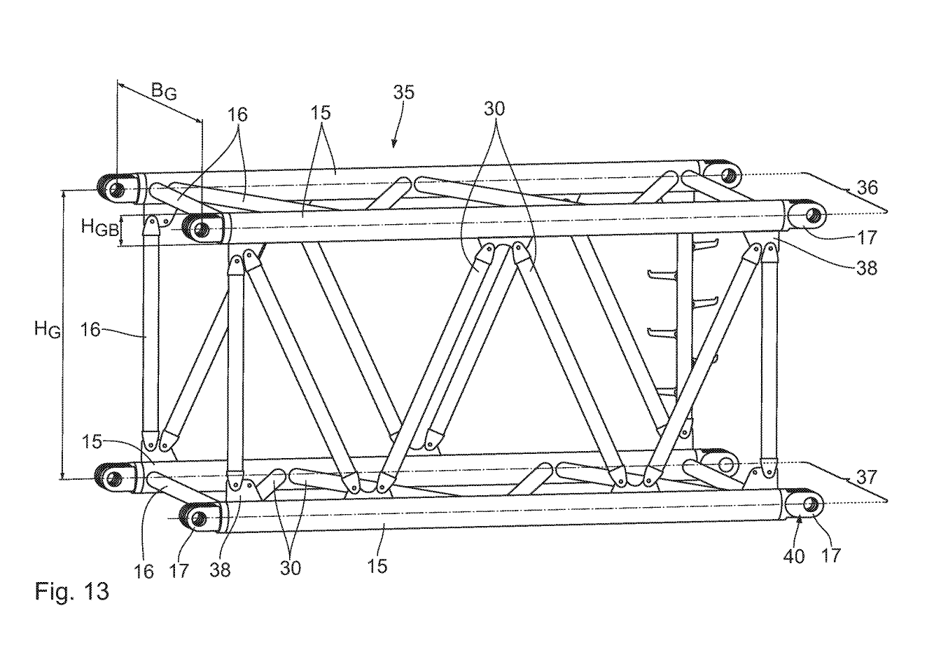

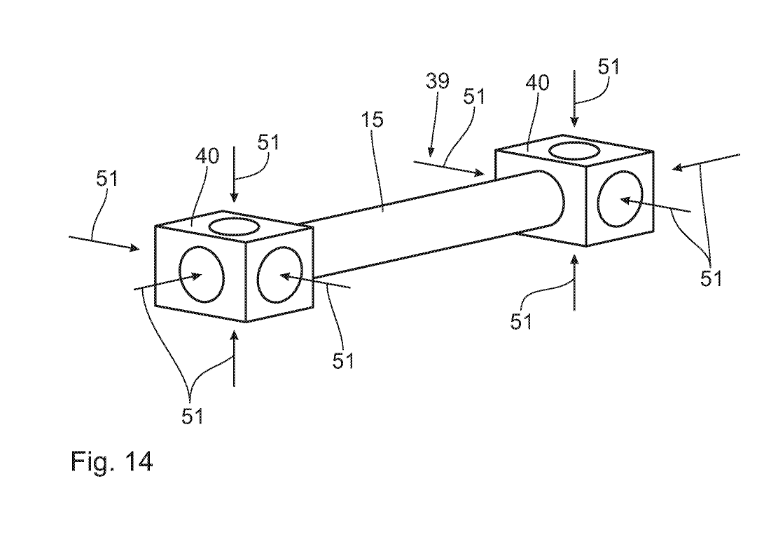

FIGS. 13 and 14 show another embodiment of a lattice mast section 35. Components corresponding to those already explained above with reference to FIGS. 1 to 12 are designated by the same reference numerals and are not discussed in detail again.

The main difference of the lattice mast section 35 compared to the preceding embodiments is that all elements of the lattice mast section 35 have a modular design. This means that the lattice mast section 35 producible therefrom has a plurality of lattice mast assemblies for instance pre-assembled individually, wherein a single tube such as a chord element 15, a null bar 16 and a diagonal bar 30 and/or the head pieces 17 may each represent an individual lattice mast assembly. A lattice mast assembly of this type allows a dimension-variable truss to be produced, in particular an open bar truss structure. It is however conceivable as well for a plurality of bars and/or tubes to be combined in pre-assembled lattice mast assemblies. In the illustrated exemplary embodiment, the upper chord 36 and the lower chord 37 are each configured as a separate lattice mast assembly. The upper chord 36 comprises two chord elements 15 arranged in a horizontal plane. Each chord element 15 has a respective head piece 17 at a front end thereof. The two chord elements 15 are interconnected in the horizontal plane by a respective null bar 16 in the region of the head pieces 17. Between the null bars 16, a plurality of diagonal bars 30 are arranged.

The lower chord 37 is configured similarly, in particular identically, to the upper chord 36. In order to connect the upper chord 36 to the lower chord 37, two null bars 16 and four diagonal bars 30 arranged therebetween are arranged in each of two parallel vertical planes. The bars 16, 30 arranged in the vertical planes are each articulated to fixing lugs 38 of the chord elements 15. Articulation to the fixing lugs 38 is in particular carried out using bolts or screws. The fixing lugs 38 are welded to the chord elements 15.

The bars forming the upper chord 36 and the lower chord 37, in particular the chord elements 15, the null bars 16 and the diagonal bars 30, are firmly and in particular permanently interconnected to form the upper chord 36 and the lower chord 37. The bars are for instance welded to each other individually. Since the chords 36, 37 according to the exemplary embodiment shown in FIG. 13 are not dividable, the lattice mast assembly width B_{GB} is equal to the lattice mast width B_{G}. The lattice mast assembly height H_{GB} is reduced considerably compared to the lattice mast height H_{G} and amounts to in particular no more than 10% of the lattice mast height H_{G}. In particular, it is conceivable to transport several lattice mast assemblies in the form of an upper chord 36 and/or a lower chord 37, the lattice mast assemblies being arranged one above the other in the form of a stack, without exceeding a maximum permissible transport height.

It is however conceivable as well to produce the modular structure of the lattice mast section 35 shown in FIG. 13 using an integral bar element 39 according to FIG. 14. The bar element 39 comprises a central chord element 15 and two connection blocks 40 arranged at the ends thereof. The connection blocks 40 allow additional bars to be joined to the bar element 39 and/or a head piece 17 to be inserted into a recess of the connection block 40 provided for this purpose. In particular, the connection blocks 40 allow additional bars to be articulated thereto in the three spatial directions indicated by the arrows 51. It is for instance conceivable to arrange the connection block 40 in such a way as to be rotatable along its longitudinal axis relative to the chord element 15, which in particular facilitates a connection to a diagonal bar. Instead of the connection blocks 40, a bayonet lock or a twistlock connection may be provided as alternative connection elements allowing the bar elements 39 to be easily and quickly connectable to other bars to achieve a modular structure for a desired lattice mast section.

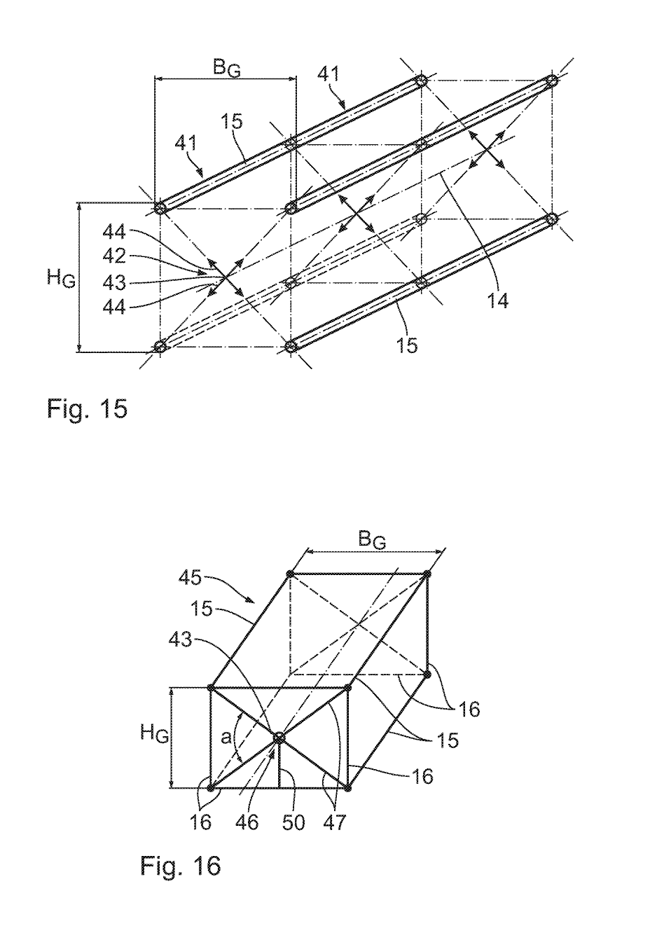

FIG. 15 shows a diagrammatic illustration of another embodiment of a lattice mast section 41. Components corresponding to those already explained above with reference to FIGS. 1 to 14 are designated by the same reference numerals and are not discussed in detail again.

The lattice mast section 41 comprises four chord elements 15 extending along the longitudinal axis 14, the chord elements 15 being arranged at the corners of a rectangular lattice mast cross-section. According to FIG. 15, two lattice mast sections 41 are arranged one behind the other along the longitudinal axis 14. The four chord elements 15 are articulated to each other by means of an articulated support structure. The articulated support structure 42 shown diagrammatically in FIG. 15 comprises an articulated element 43 arranged centrally on the longitudinal axis 14. The articulated element 43 further comprises four telescopic elements 44, in particular telescopic cylinders, extending away from the articulated element 43 in a substantially radial direction relative to the longitudinal axis 14 in the cross-sectional plane. The telescopic elements 44 are indicated by arrows in FIG. 13. The arrows signify that starting from the articulated element 43, each of the telescopic elements 44 is adjustable both in length and force in the directions represented by the arrows. For instance, it is conceivable as well for a telescopic element 44 to be configured as a spindle drive or in the manner of a clamping nut. The telescopic elements 44 are actuable in such a way as to expand from the central articulated element 43 to span a rectangle, the chord elements 15 being arranged at the corners thereof. The chord elements 15 are connectable to the telescopic elements 14.

For a transport arrangement of the lattice mast section 41 shown in FIG. 15, the chord elements 15 are separated from the telescopic elements 44. The individual chord elements 15 can be transported together with the articulated support structures 42 separated therefrom in a substantially flat and space-saving manner. In this context, “flat” means that length and width of the articulated support structure 42 are in each case considerably larger than a height in a direction perpendicular to a plane spanned by the width and length thereof. The articulated support structures 42 are flat elements. In particular, a length-to-height or width-to-height ratio of the articulated support structure 42 in each case amounts to at least 5, in particular at least 10 and in particular at least 20. It is conceivable as well to configure the articulated support structure 42 such as to be dividable; it is for instance conceivable for the individual telescopic elements 44 to be detachably connected to the articulated element 43. This allows the individual lattice mast assemblies, in other words the chord elements 15, the telescopic elements 44 and the articulated element 43, to be transported in a space-saving manner. According to FIG. 14, the lattice mast assemblies are substantially bar-shaped or configured as modular elements, with each of them having a lattice mast assembly width and a lattice mast assembly height smaller than the lattice mast width B_{G} and the lattice mast height H_{G}.

It is conceivable to interconnect the chord elements 15 of the lattice mast section 41 by additional diagonal bars and/or null bars not shown, for instance in a manner similar to the lattice mast section 35. It is conceivable to replace the articulated element 43 and/or the telescopic elements 44 by null bars 16 and/or diagonal bars 30 after setting a necessary lattice mast cross-section. For example, this means that only four chord elements 15, two articulated elements 43 and eight telescopic elements 44 are required to assemble a lattice mast section 41. Once a necessary lattice mast cross-section has been formed and the chord elements 15 have been interconnected and spaced from each other using the connection bars 16, 30, the movable elements, in other words the articulated element 43 and the telescopic element 44, can be used to form new lattice mast cross-sections. Using the null bars 16 and/or diagonal bars 30 allows the lattice mast section to be provided in a cost-effective manner.

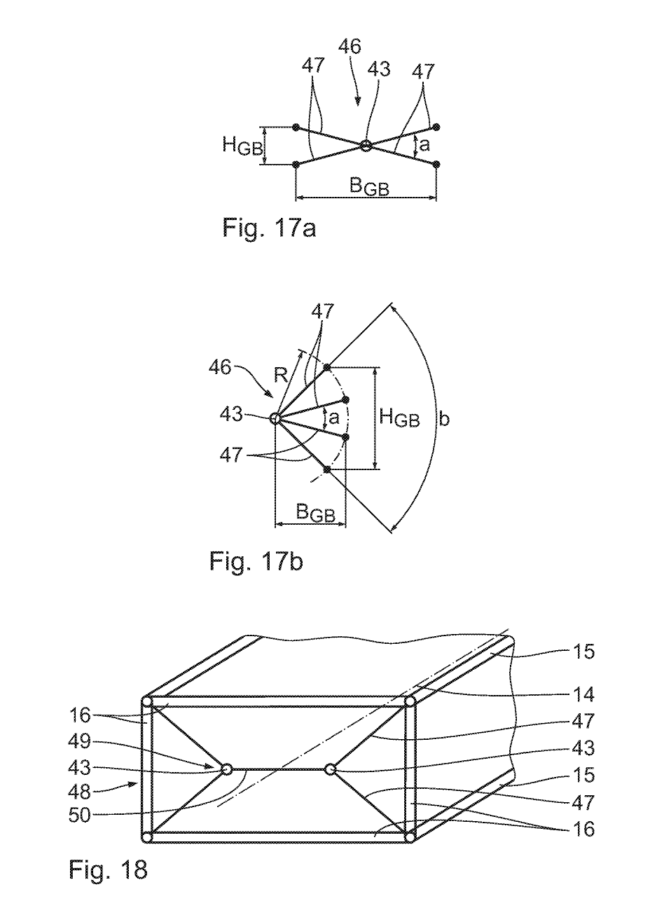

FIGS. 16a, 16b and 17 show further embodiments of a lattice mast section 45. Components corresponding to those already explained above with reference to FIGS. 1 to 15 are designated by the same reference numerals and are not discussed in detail again.

In contrast to the lattice mast section 41, an articulated support structure 46 of the lattice mast section 43 has a central articulated element 43 and two or four articulated bars 47 articulated thereto. The articulated bars 47 are articulated to the articulated element 43 in such a way as to be rotatable about the articulated element 43 in the drawing plane shown in FIGS. 14 and 15. The articulated element 43 is in particular arranged concentrically to the longitudinal axis 14 of the lattice mast section 45. The articulated support structure 46 is arranged in the plane oriented perpendicular to the longitudinal axis 14. FIG. 17a shows the articulated support structure 46 in a transport arrangement. In each case two articulated bars 47 are folded such as to form a pair, in other words they are arranged adjacent to each other. An opening angle a between the two folded articulated bars 47 in the transport arrangement for instance amounts to no more than 10°, in particular no more than 5°, and in particular no more than 3°. A similar articulated support structure 26 shown in FIG. 17b comprises four articulated bars 47 arranged in a transport arrangement. Each of the articulated bars 47 is freely rotatable about the articulated element 43 in the manner of a hinge. An opening angle a between two adjacent, freely rotatable articulated bars 47 in the transport arrangement for instance amounts to no more than 5°, in particular no more than 3°. A total opening angle b between two outer articulated bars 47, in other words a transport opening angle, amounts to approximately three times the opening angle a between the two inner articulated bars 47. In particular, the total opening angle b amounts to no more than 15° and in particular no more than 10°. The lattice mast assembly height H_{GB} is greater than that of the exemplary embodiment shown in FIG. 17a. The lattice mast assembly width B_{GB} on the other hand has been reduced to half. In contrast to the articulated support structure 46 in FIG. 17a, which has substantially rectangular transport dimensions due to the fact that the lattice mast assembly height H_{GB} is considerably smaller than the lattice mast assembly width B_{GB}, the articulated support structure 46 according to FIG. 17b has a substantially square shape in the transport arrangement. This allows the lattice mast assembly width B_{GB} to be varied even more, thus allowing an available transport space to be used as efficiently as possible. The articulated support structure 46 according to FIG. 17b provides higher flexibility when arranging the articulated element in the transport arrangement.

The articulated support structure 46 is a lattice mast assembly having a lattice mast assembly height H_{BG} and a lattice mast assembly width B_{GB}.

FIG. 16 shows the lattice mast section 45 in a working arrangement. The articulated support structure 46 is folded open, in other words the articulated bars 47 are pivoted about the longitudinal axis 14 such that the opening angle a between two adjacent articulated bars 47 is increased. Depending on the design of the lattice mast section 45, in other words depending on the desired lattice mast width and/or lattice mast height, the angle a may vary in the working arrangement. According to the embodiment shown in FIG. 16, the angle a amounts to approximately 70°. It is conceivable as well for the angle a to amount to less than 70° or more than 70° in the working arrangement. At free ends remote from the articulated element 43, the articulated bars 47 are in each case connected to a chord element 15 oriented along the longitudinal axis 14, and to two null bars 16. It is conceivable as well that the articulated bars 47 are connected, in particular articulated, to the respective chord element 15 permanently so that the chord elements 15 are secured to the articulated support structure 46 even in the transport arrangement thereof. In this case, the chord elements 15 are part of the lattice mast assembly of this embodiment.

Converting the lattice mast section 45 or the articulated support structure 46 from the transport arrangement in FIG. 17 into the working arrangement in FIG. 16 may for instance be done manually. It is conceivable as well to use auxiliary means such as telescopic cylinders or other linearly displaceable units or cranes or setting-up means. To prevent the articulated support structure 46 from moving back into the transport arrangement automatically as a result of gravity, for example, null bars 16 are mounted between the chord elements 15 of the upper chord and the chord elements 15 of the lower chord, the null bars 16 being oriented vertically. In addition thereto, it is conceivable to arrange diagonal bars (not shown) between the chord elements 15. In addition or as an alternative thereto, it is conceivable as well to provide the articulated element 43 with a locking device in such a way that the articulated support structure 46 is locked in the working arrangement shown in FIG. 16, thus increasing the stiffness of the articulated support structure 46 even more. A locking device of this type may for instance be configured as a bolt connection. In order to reinforce the articulated support structure 46, a vertically oriented bar element may be provided that is arranged between one of the null bars 16 and the articulated element 43. The bar element 50 is in particular oriented vertically. As a result, the lattice mast section 45 has an increased stiffness and is able to absorb greater lateral forces. It is conceivable as well to provide more than one bar element 50.

In a working arrangement shown in FIG. 16, the lattice mast section 45 has a lattice mast width B_{G} and a lattice mast height H_{G}. The lattice mast assembly height H_{GB} is smaller than the lattice mast height H_{G}, amounting in particular to no more than 20% of the lattice mast height H_{G}, in particular to no more than 10% of the lattice mast height H_{G}, and in particular to no more than 7% of the lattice mast height H_{G}.

FIG. 18 shows another embodiment of a lattice mast section 48. Components corresponding to those already explained above with reference to FIGS. 1 to 17 are designated by the same reference numerals and are not discussed in detail again.

The lattice mast section 48 is similar to the lattice mast section 45, with the articulated support structure 49 of the lattice mast section 48 having two articulated elements 43 interconnected by means of a bar element 50 so as to be arranged at a defined distance from each other. The bar element 50 may be configured as a pendulum support. The pendulum support is able to absorb compressive and tensile forces along its longitudinal axis. The use of the additional bar element 50 and another articulated element 43 results in a greater degree of freedom for the design of the articulated support structure 49, and therefore for the lattice mast section 48, in particular the lattice mast cross-sectional surface area thereof. The bar element 50 is in particular used to lock the articulated support structure 49. When locked, the lattice mast section 48 has an increased stiffness and therefore a greater stability. The lattice mast section is able to absorb increased lateral forces. The handling, in particular the conversion from a transport arrangement (not shown) into the working arrangement of the lattice mast section 48 shown in FIG. 18, is similar to that of the embodiment described in FIGS. 16 and 17. It is conceivable for the articulated elements 43 to be detachably connected to the bar element 50. In this case, the bar element 50 and the two articulated elements 43 form in each case one lattice mast assembly with the articulated bars 47 articulated thereto. It is conceivable as well that the entire articulated support structure 49 forms a lattice mast assembly.

According to the preceding exemplary embodiment of the lattice mast section 48 shown in FIG. 18, the free ends of the articulated bars 47 are in each case connected to a chord element 15 and two null bars. The individual chord elements 15 are interconnected by null bars 16.

1-15. (canceled)

16. A multi-component lattice mast section comprising
a. a longitudinal axis,
b. a plurality of chord elements extending along the longitudinal axis,
c. a plurality of connection bars interconnecting in each case two adjacent chord elements,
d. a lattice mast cross-sectional surface area oriented perpendicular to the longitudinal axis, the surface area having a lattice mast width and a lattice mast height, and
e. at least two detachably interconnectable lattice mast assemblies,
wherein each of the lattice mast assemblies has at least one of the group comprising:
f. a lattice mast assembly width smaller than the lattice mast width and
g. a lattice mast assembly height smaller than the lattice mast height, and wherein the connection bars being firmly connected to a chord element in a working arrangement, characterized by four chord elements extending along the longitudinal axis, the chord elements being interconnected by an articulated support structure.

17. The lattice mast section according to claim 16, wherein the lattice mast assembly width and the lattice mast assembly height do not exceed maximum permissible dimensions for a transport on public roads.

18. The lattice mast section according to claim 16, wherein at least one of the group comprising the lattice mast assembly width and the lattice mast assembly height amounts to no more than 4.0 m.

19. The lattice mast section according claim 16, comprising connection bars in the form of at least one of the group comprising null bars and diagonal bars.

20. The lattice mast section according to claim 16, wherein the lattice mast assemblies are configured identically.

21. The lattice mast section according to claim 16, wherein the lattice mast assemblies form in each case one of the group comprising a half and a quarter of the lattice mast cross-sectional surface area.

22. The lattice mast section according to claim 21, wherein the lattice mast assembly width and the lattice mast assembly height amount to no more than half of the lattice mast width and the lattice mast height, respectively.

23. The lattice mast section according to claim 21, wherein the lattice mast assembly width and the lattice mast assembly height amount to no more than a quarter of the lattice mast width and the lattice mast height, respectively.

24. The lattice mast section according to claim 16, wherein the articulated support structure is arranged in a plane oriented perpendicular to the longitudinal axis.

25. The lattice mast section according to claim 16, wherein two adjacent chord elements are interconnected by a null bar.

26. The lattice mast section according to claim 16, wherein the articulated support structure has a central articulated element and four articulated bars articulated thereto.

27. The lattice mast section according to claim 26, wherein the central articulated element of the articulated support structure is arranged concentrically to the longitudinal axis.

28. The lattice mast section according to claim 26, wherein the articulated support structure has two articulated elements and in each case two articulated bars articulated thereto, the articulated elements being interconnected by a pendulum support.

29. A crane comprising at least one component selected from the group consisting of (a) a lattice tower having a lattice mast and (b) a lattice boom having a lattice mast, wherein each said lattice mast comprises at least one lattice mast section according to claim 16.
